(19) United States
(12) Patent Application Publication
(10) Pub. No.: US 2012/0173580 A1
(43) Pub. Date: Jul. 5, 2012

(54) Event Feedback Networking System

(76) Inventors: Donato Diorio, Oconomowoc, WI (US); Casey Kerr, Waukasha, WI (US)

(21) Appl. No.: 12/981,331

(22) Filed: Dec. 29, 2010

(51) Int. Cl. G06F 17/30; G06F 7/00

(52) U.S. Cl. 707/781; 707/803; 707/805; 707/E17.044; 707/E17.032

(57) ABSTRACT

The present invention is an event feedback networking system configured to facilitate intuitive participant response. The event feedback networking system utilizes novel distributed hardware components and novel data structures for obtaining, processing, analyzing, and displaying intuitive user feedback.

### FIELD OF INVENTION

The present invention is a computer apparatus for measuring, displaying and compiling data related to human cognitive reactions to a defined event.

### BRIEF DESCRIPTION OF THE DRAWINGS

FIG. 1 is an exemplary embodiment of an event feedback networking system.

FIG. 2 illustrates an exemplary embodiment of a real-time event feedback system which provides two-way feedback to users.

FIG. 3a illustrates an exemplary embodiment of an event feedback networking system with a closed group of participants.

FIG. 3b illustrates an exemplary embodiment of an event feedback networking system with an open group of participants.

FIG. 4 is an exemplary embodiment of an event feedback networking system which is capable of creating time-segmented event data.

FIG. 5 illustrates an exemplary embodiment of an event feedback networking system in which data is processed and provided to data recipients correlated with sampled time units.

FIG. 6 illustrates an exemplary revenue model with backend revenue processing.

### GLOSSARY

As used herein, the term “backend processor” refers to a computer processor configured with software for processing and recording payment transactions.

As used herein, the term “data recipient” means an entity, individual or computer component that requests data. A data recipient may create a data request object and/or invoke functions for processing data. Data may include spontaneous user feedback, demographic data, or any other data capable of being received, collected or produced by the components of an event feedback networking system.

As used herein, the term “distributed” means that physical components, data recipients, and/or participants may be in a single location or in multiple locations.

As used herein, the term “event” means an experience which may be shared by more than one participant and for which a measurable, cognitive response may be elicited. An event may be experienced by each participant at different times, in different locations, in different formats or in different segments of the event.

As used herein, the term “event feedback database” refers to stored event records, feedback records, and participant records. An event feedback database may reside on a single server or across multiple servers.

As used herein, the term “event record” means an occurrence reflected as a record in a database. Information contained in an event record may include, but is not limited to, the name, time, geographical location, type, and sponsor of an event.

As used herein, the term “event record object” means a compilation of attributes and behaviors that encapsulates an event record.

As used herein, the term “feedback” or “spontaneous user feedback” means a measurable, cognitive response or information a participant provides in response to an event. Feedback may include, but is not limited to, voting, manipulation of a computer component, physical responses, and providing ratings, rankings and biofeedback, and indications of change, no change, user participation and user non-participation.

As used herein, the term “feedback record” means a data structure in which data derived from user feedback is stored.

As used herein, the term “feedback record object” means any data structure that includes at least one attribute and/or function for user creating, changing and manipulating user feedback objects that encapsulate a feedback record.

As used herein, the term “group attribute” means an attribute that defines a group or participants which can instantiate and modify user feedback record objects.

As used herein, the term “instantiate” means to create an instance of a software object.

As used herein, the term “invoke” means to call a function.

As used herein, the term “network connection” means any software or hardware that allows two or more computers or devices to communicate with one another.

As used herein, the term “record object” or “object” means a data structure which includes data attributes and functions which define the functionality of an apparatus.

As used herein, the term “participant input device” or “intuitive input device” means any device capable of receiving input used to modify at least one user feedback object. A participant communication device may be any form of input hardware including, but not limited to, keyboards, iPods™, personal listening and viewing devices, telephony, devices capable of measuring biofeedback, kinetic sensing devices which measure the presence or absence of motion, facial recognition and video and audio recorders. A participant input device may include an intuitive input device if it is designed to make the user comfortable or unaware with the device so that cognitive thought related to the process of providing feedback is minimized or not needed for the collection of user feedback.

As used herein, the term “participant record” means a data structure which stores data and/or attributes associated with a participant. Examples of data which may be included in a participant record include, but are not limited to, demographic data, user IDs, and information contained in a social network profile (SNP) record.

As used herein, the term “participant record object” means a compilation of attributes and behaviors that encapsulate a participant record.

As used herein, the term “physical storage component” means any physical data storage device, including, but not limited to, computer memory, disks, internal or external hard drives, flash drives, and other memory devices.

As used herein, the term “rate plan tracking mechanism” means one or more devices configured individually or in combination to track payment and the amount received as payment for data.

As used herein, the term “real time” means during a single user session, event, an instance, time segment of an event, time segment related to an external measurement, or other time period defined by a user, participant, data recipient or administrator.

As used herein, the term “record” means related data treated as a unit.

As used herein, the term “revenue processing component” means any software or hardware component utilized for processing payments or credits or validating user privileges associated with the exchange of data.

As used herein, the term “sampled time unit” means a measurable unit of time into which the duration of an event is segmented.

As used herein, the term “segment” means a unit that represents a portion of data associated with an event object or record or an event in progress. For example, a time segment means a portion of an event which occurred within a specific time frame.

As used herein, the term “time segmenting function” means a function that segments an event record into time intervals.

As used herein, the term “unique device identification number attribute” refers to an attribute of a participant record object that associates a specific participant with a specific input device.

As used herein, the term “user feedback measurement function” means a function that measures changes in at least one attribute of a feedback record object or record.

As used herein, the term “user interface” is an interface that allows a user to enter input and to interact with one or more components and/or record objects of an event feedback monitoring system.

As used herein, the term “viewable feedback interface” refers to any means of communication between an event feedback database and a user that allows the user or data recipient to view feedback.

### BACKGROUND

Millions of events are broadcast, televised, hosted and staged each day. Events generally are intended for more than one participant, although an event may be experienced at different, times, locations and through different media for various participants. Participants may also view or be present during only part of an event.

Events may be intended to communicate, entertain, and/or educate. However, all events evoke a unique cognitive response from each participant.

Companies, television networks, training professionals, and event sponsors seek public opinion regarding the effectiveness of advertisements, scheduling of television shows, entertainment value of events, and a myriad of other qualities of the services provided. Focus groups and surveying participants or viewers may be used to receive feedback regarding advertisements, television shows, or other events. Focus groups and surveys, however, are costly and may be conducted in environments and under circumstances which by their very nature alter the spontaneity of the user response.

Electronic survey devices may allow participants to respond to particular questions and prompts instantaneously, but these devices lack the capability and are not designed to continuously compile data in real time and do not offer two-way, interactive feedback to users as they are providing feedback.

Electronic survey devices do not capture continuous, spontaneous and intuitive responses. Participants may be limited by responding to a prompt or cue.

Additionally, methods of surveying users in real time have traditionally required the involvement of event creators and sponsors.

Methods and tools in the art are not adapted to allow participants to spontaneously view or otherwise participate in an event and provide feedback in their own environment without the involvement of event creators and sponsors.

Tools known in the art are not designed to provide two-way feedback to participants to alter the participants' response or choice of event during the feedback gathering process. These tools are not designed to take into account a population demographic which is conditioned to use social networking tools and may desire to provide feedback as part of an overall social networking experience.

It is desirable to provide a system of collecting participant feedback from both closed groups of participants and open groups of participants.

It is further desirable to provide a system of collecting participant feedback where participants may respond instantaneously and intuitively.

### SUMMARY OF THE INVENTION

The present invention is an event feedback networking system configured to facilitate intuitive participant response. The event feedback networking system utilizes novel distributed hardware components and novel data structures for obtaining and processing user feedback. In various embodiments, the apparatus may be configured to process novel data structures including, but not limited to, event record objects, feedback record objects, participant record feedback objects, and one or more hardware components, such as a processor which may process data, segment events, respond to data requests by data recipients and process event record objects and participant record objects when the functions of a feedback record object are invoked.

### DETAILED DESCRIPTION OF INVENTION

For the purpose of promoting an understanding of the present invention, references are made in the text to exemplary embodiments of software and hardware components for collecting and analyzing real-time participant feedback and communicating with participants in a social networking environment, only some of which are described herein. It should be understood that no limitations on the scope of the invention are intended by describing these exemplary embodiments. One of ordinary skill in the art will readily appreciate that alternate but functionally equivalent hardware, computer components, software objects, and other data structures may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

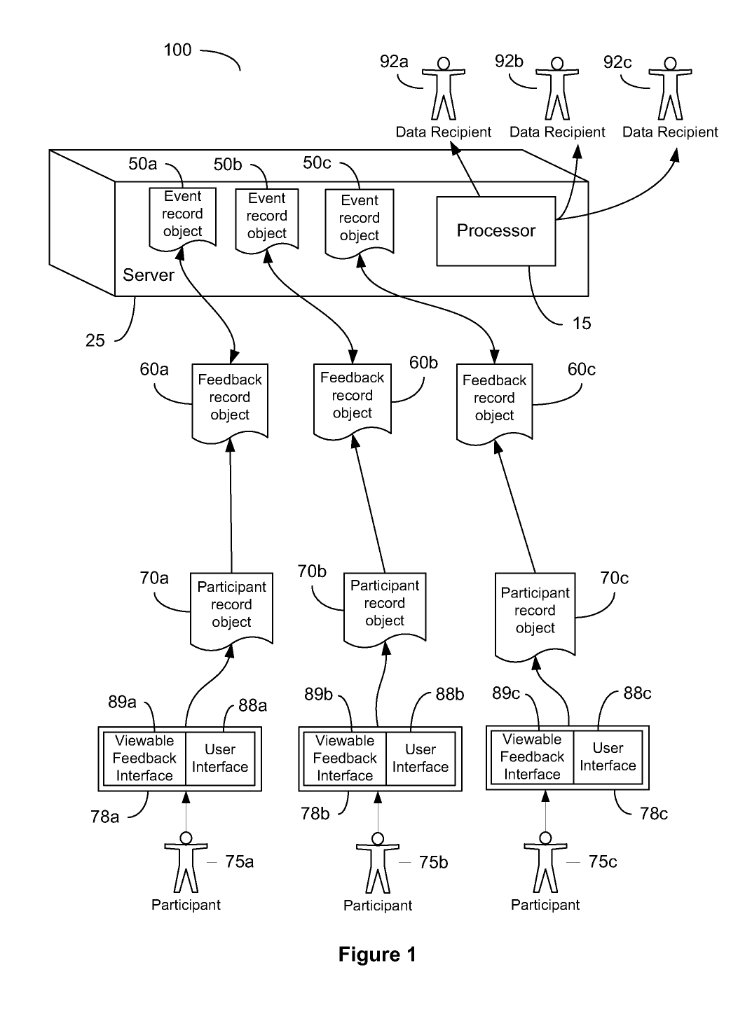

FIG. 1 is an exemplary embodiment of event feedback networking system 100. The exemplary embodiment shown includes user interface 88 which is in communication with at least one server 25 which includes at least one processor 15. In the exemplary embodiment shown, server 25 includes event record objects 50a, 50b and 50c which may be created by an administrator and displayed via user interface 88, or which may be created on a spontaneous and/or continuous basis by participants 75a, 75b, and 75c.

In the embodiment shown, exemplary event record object 50a is a software object which includes data pertaining to an event which is a live concert attended by participants 75a, 75b, and 75c. The event associated with event record object 50b is a televised political speech, and the event associated with event record object 50c is a television show.

In various embodiments, server 25 may store and update any number of event record objects which may be instantiated and modified by a user, administrator, event host, participant, or any other person or entity authorized to instantiate an event record object.

In the exemplary embodiment shown, participants 75a, 75b, and 75c are associated with participant record objects 70a, 70b, and 70c. Participant record objects 70a, 70b, and 70c are configured with functions that allow a user to create and/or modify attributes of an event record object 50a and to instantiate feedback record objects 60a, 60b, and 60c through user interface 88.

Participant record objects 70a, 70b, and 70c include attributes and data associated with a specific user. Participant record objects 70a, 70b, and 70c may further include functions for modifying such attributes.

In the embodiment shown, feedback record objects 60a, 60b, and 60c are modified by user actions performed by participants 75a, 75b, and 75c on user interface 88. Values and attributes of feedback record objects 60a, 60b, and 60c are passed to processor 15 for compilation, tracking, tabulation, scoring and display and for use by data recipients 92a, 92b, and 92c who may purchase feedback data. In various embodiments, feedback data may or may not undergo additional processing for use by data recipients 92a, 92b, and 92c.

Event record objects 50a, 50b, and 50c contain data related to any known attributes pertaining to a particular occurrence or event, including, but not limited to, the name, time, location and sponsor of the event or any event data that can be represented symbolically, mathematically or linguistically. Cursory examples of events may include, but are not limited to, advertisements, television shows, movies, live concerts or broadcasts, dining experiences, sporting events, political debates, training exercises, assignments, travel experiences, and other relatable experiences.

In various embodiments, participants 75a, 75b, and 75c may invoke functions through a user to modify and/or update attributes of a specific participant record or object, such as age, gender, location, and any other demographic information that may be compiled about a participant. In exemplary embodiments, participant record objects 70a, 70b, and 70c may also be linked to a social network profile (SNP) created by user or a third party administrator of such profiles (e.g., MySpace or Facebook).

Feedback record objects 60a, 60b, and 60c may be updated by any function known in the art for measuring feedback and reactions of participants 75a, 75b, and 75c in response to an event. In various embodiments, participant feedback may include responses consciously submitted by a participant, such as a rating or indication along a sliding scale, and unconscious responses, such as recorded laughter or skin conductivity. Processor 15 is configured to modify event record objects 50a, 50b, and 50c and participant record objects 70a, 70b, and 70c when the functions of feedback record objects 60a, 60b, and 60c are invoked.

In the embodiment shown, participant 75a enters feedback using participant input device 78, and attributes of participant record object 70a may be modified based on participant input. Feedback record object 60a may also be modified or instantiated.

In still other embodiments, participant input device 78 may be equipped with attributes which are modified in response to changes in location, participant position, participant input (such as manipulating a touch pad or galvanometer), biofeedback, audio feedback, incrementation, or any other method or instrument known in the art to identify any form of user response capable of being measured and/or quantified and further used to modify attributes of feedback record objects 60a, 60b, and 60c.

In various embodiments participant input device 78 may be an intuitive input device configured with any sensor, tracking component, video or audio device, ergonomic or anthropometric physical contour or configuration to make the process of providing feedback as intuitive as possible for a user.

In various exemplary embodiments, participant input device 78 may include a keyboard, typewriter, cash register, touch-sensitive computer interface, voice recognition device, the certificate itself, paper document, a wireless device, laptop computer, mobile phone, personal information device, personal digital assistant, hand-held device, network appliance, pager, an analog device or a device used manually, microphones, touch-sensitive displays, transducer card readers, magnetic or paper tape readers, tablets, styluses, voice or handwriting recognizers, a server, a mechanism capable of reading biological information, a document reader or scanner, any other recording device commonly known and used in the art, and combinations thereof.

Processor 15 measures the change in participant record object 70a and feedback record object 60a to update feedback record object 60a and event record object 50a. In further embodiments, processor 15 may also be adapted to display updated information on user interface 88.

In other embodiments, participant input device 78 may be an intuitive input device adapted to receive biofeedback and other nonconscious responses to an event. For example, in another embodiment, participant input device 78 may contain a galvanometer to record skin conductivity. In another embodiment, participant input device 78 may be adapted to record heart and respiration rates. In still other embodiments, participant input device 78 may contain an audio or visual recording device to record verbal or facial responses.

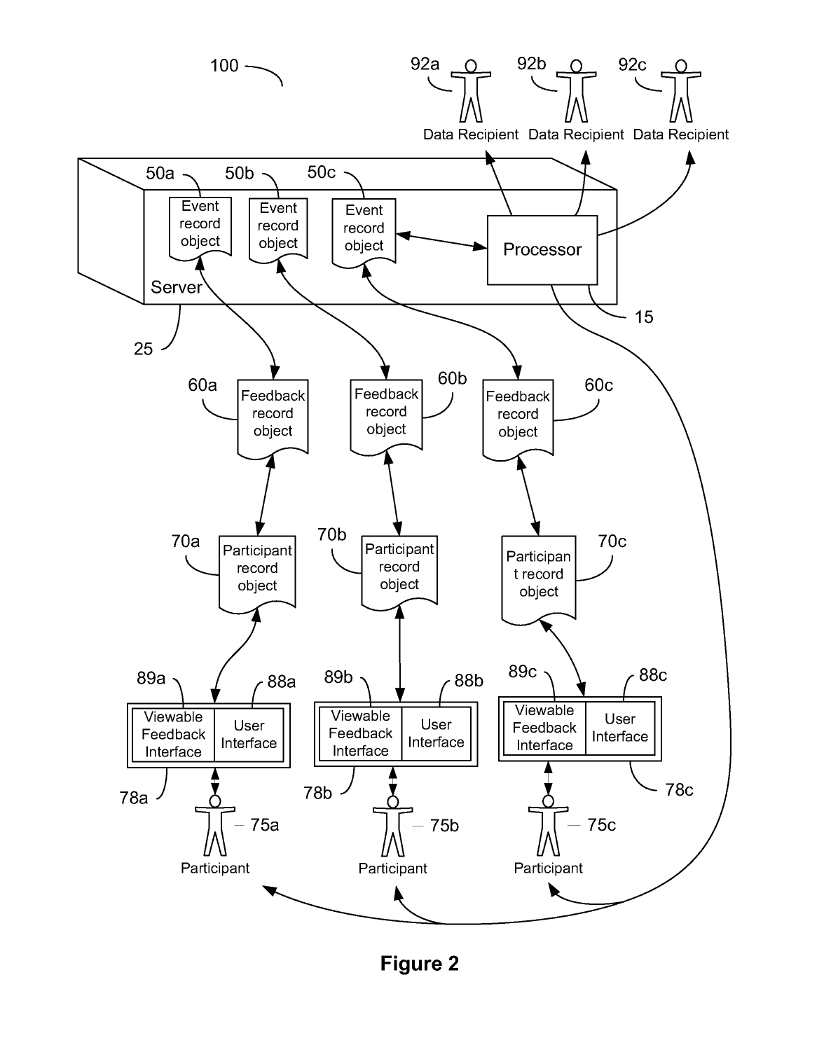

FIG. 2 illustrates an exemplary embodiment of event feedback networking system 100 providing two-way feedback to users and which includes viewable feedback interface 89. Participant 75 enters event feedback using participant input device 78 which may be configured for intuitive feedback. Participant input device 78 establishes network connection 79 with event feedback networking system 100 and feedback is stored in feedback record object 60. Feedback record object 60 is located in physical storage component 10. Feedback record object 60 is associated with event record object 50 and feedback stored in feedback record object 60, and may be displayed with viewable feedback interface 89.

In the embodiment shown in FIG. 2, participant 75 is responding to a televised event. In other embodiments, participants may respond to any televised or non-live event, including, but not limited to, podcasts and web conferences. In still further embodiments, participants may be able to respond to any live event, including, but not limited to, sporting events, political debates, lobbying events, training and teaching exercises, simulated events, customer experiences, and other personal experiences to provide a semi-real time emotional response.

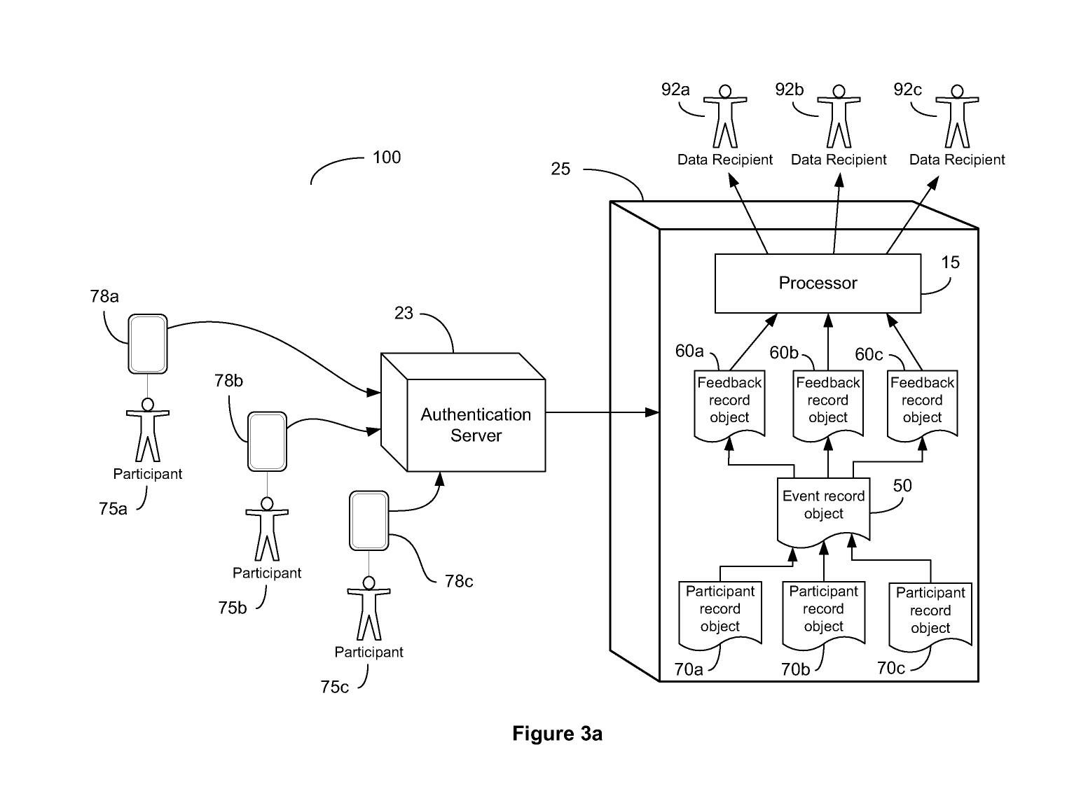

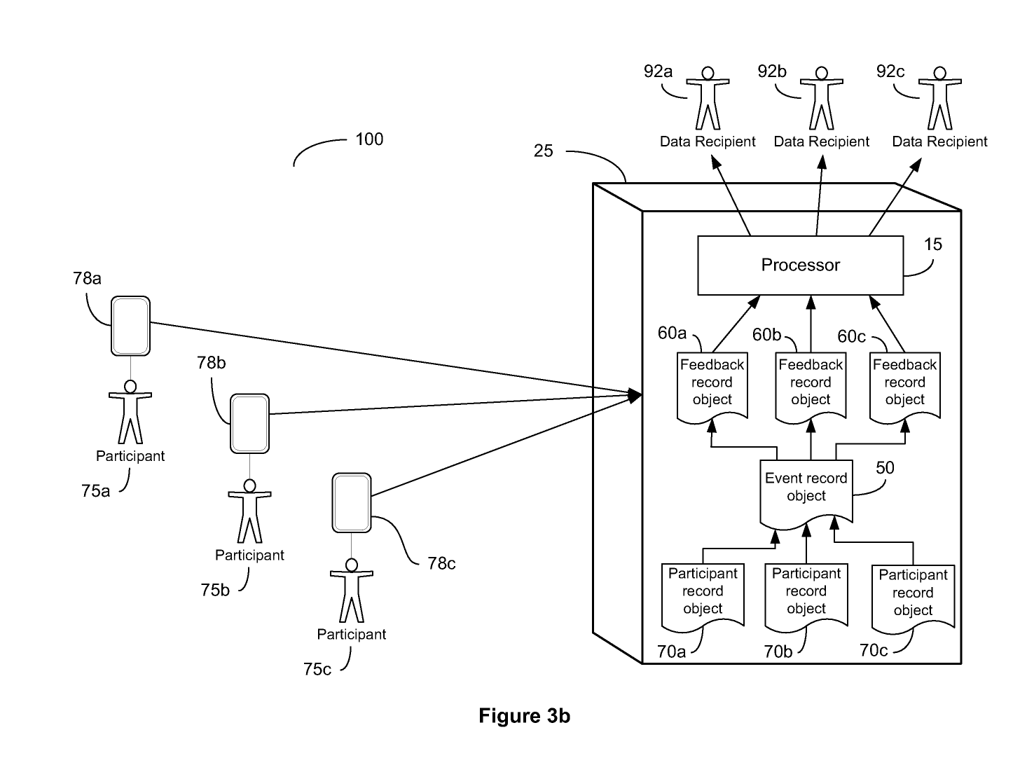

FIGS. 3a and 3b illustrate exemplary embodiments of event feedback networking system 100 in use by both a closed group of participants 75a, 75b, and 75c and an open group of participants 75d, 75e, and 75f.

In various embodiments, each participant in either an open or closed participant group may be assigned a unique identification number or may use a participant input device 78 assigned a unique device ID number. In still other embodiments, participant record identifying information and device ID numbers may be used by a participant to log into an event record and provide feedback for that event.

FIG. 3a illustrates an embodiment of event feedback networking system 100 in which a closed group of participants must enter a code or access a designated device and be validated by a user validation processor. In the exemplary embodiment shown, closed group of participants 75a, 75b, and 75c are selected for survey and data gathering, and provided with authorization and access to create and/or modify feedback record objects 60. FIG. 3a further includes authentication server 23 for providing functions such as creating participant record objects 70a, 70b, and 70c, deleting participant record objects 70a, 70b, and 70c, authenticating participants attempting to access participant record objects 70a, 70b, and 70c, modifying participant record objects 70a, 70b, and 70c and managing access to event record objects 50a, 50b, and 50c and one or more user interfaces 88.

In the exemplary embodiment shown in FIG. 3a, feedback record object 60 contains a group attribute which may only be modified by a closed group of participants. Participants 75a, 75b, and 75c use participant input devices 78a, 78b, and 78c to enter feedback about an event. Feedback is stored in feedback record object 60, and processor 15 measures changes in feedback record object 60 using a user feedback measurement function. Feedback record object 60 and event record object 50 are located on physical storage component 10. In further embodiments, feedback may be visually or graphically displayed.

FIG. 3b is an exemplary embodiment of event feedback networking system 100 with an open group of participants. Feedback record object 60 contains a group attribute which indicates that feedback will be accepted from any participant with privileges to instantiate or modify feedback record object 60. Participants 75d, 75e, and 75f use participant input devices 78d, 78e, and 78f to enter feedback about an event. Feedback is stored in feedback record object 60, and processor 15 measures changes in feedback record object 60 using a user feedback measurement function. Feedback record object 60 and event record object 50 are located on physical storage component 10. In further embodiments, feedback may be visually or graphically displayed.

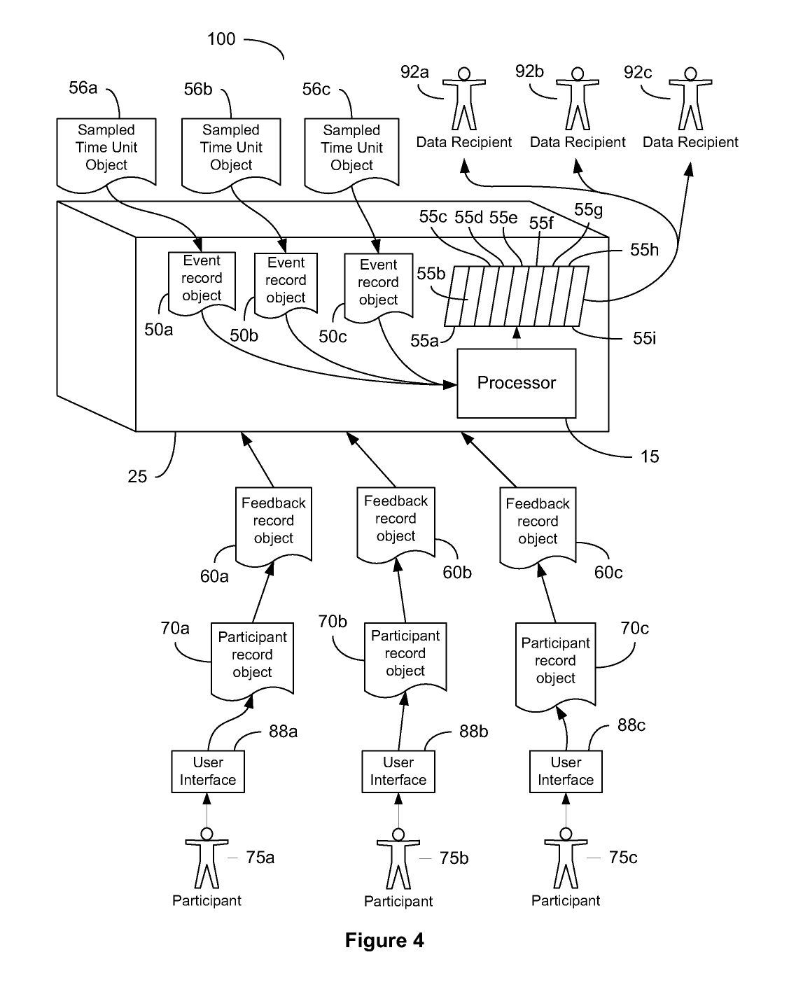

FIG. 4 is an exemplary embodiment of event feedback networking system 100 which is capable of creating time segmented event data. In the embodiment shown, event record objects 50a, 50b, and 50c may include or respond to functions invoked by other objects which cause events to be broken down into sampled time units 55a, 55b, and 55c by modifying event record objects 50a, 50b, and 50c or instantiating separate sampled time unit objects 56a, 56b, and 56c.

In further embodiments, events may be broken down into units or event record objects, and sampled time unit objects may be modified and/or instantiated based on other defining intervals, such as presenter, topic, course or location.

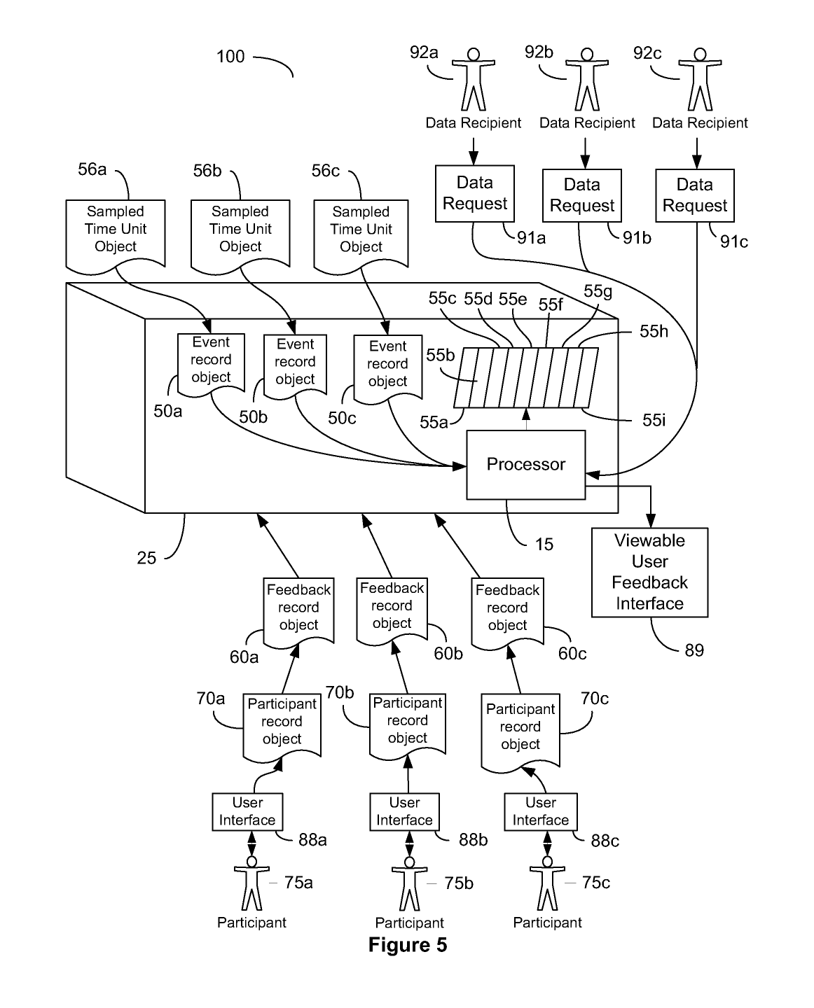

FIG. 5 illustrates an exemplary embodiment of event feedback networking system 100 in which data is processed and provided to data recipients 92a, 92b, and 92c correlated with sampled time units 55a, 55b, and 55c.

In further embodiments, feedback may be graphically displayed on viewable feedback interface 89, and data recipients 92a, 92b, and 92c may create data requests 91a, 91b, and 91c. For example, data may include, but is not limited to, data of users and data collected using user feedback objects. Data may be extracted from real time feedback, sampled feedback, time-segmented feedback, post-event feedback, comparative data, randomized data, matched data sets, statistically filtered data, demographically filtered data, and/or data filtered by an identifiable or randomized group characteristic. Data may further include data derived from comparison of user feedback from multiple events in real time, or data which is matched and compared for any number of real-time and past events, including data derived from time segments of events.

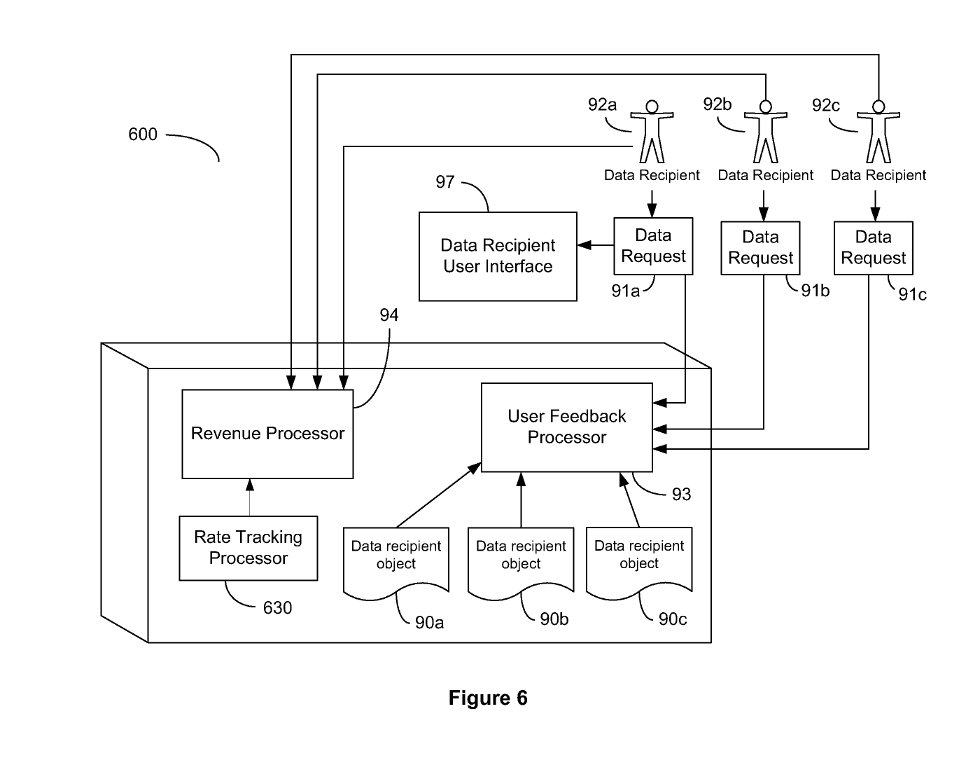

FIG. 6 illustrates an exemplary revenue model with backend revenue processing 500. Physical storage component 10 contains data recipient object 90, which is configured with attributes and functions to enable data recipient 92 to receive user feedback. Data recipient 92 may purchase raw, compiled or analyzed data. Data recipients may include, but are not limited to, market analysts, companies, corporations, market surveyors, advertising agencies, event hosts, consumer groups, political analysts, political candidate groups, and any other group who wants data and will pay for it. User feedback processor 93 processes data requested by data recipient object 90.

Back end processor 94 with user interface 95 processes revenue and payment transactions from data recipient 92 using a defined rate plan and rate tracking mechanism. The term “rate plan” as used herein means a distribution of revenue from the sale of data or among one or more data recipients, based upon policies, percentages and statistical or other information.

In further embodiments, data requests by a data recipient may be facilitated by a data recipient user interface 97 configured to accept data requests.

What is claimed is:

1. An distributed computer apparatus comprised of:
at least one intuitive input apparatus configured to communicate with at least one server component;
at least one physical storage component configured to store at least one event record object, at least one feedback record object, and at least one participant record object; and
at least one processor configured to modify said at least one event record object and said at least one participant record object when the functions associated with said at least one feedback record object are invoked.

2. The distributed computer apparatus of claim 1 wherein said at least one event record object includes at least one time segmenting function.

3. The distributed computer apparatus of claim 1 wherein said at least one event record object includes data which can be used to create sampled time unit objects.

4. The distributed computer apparatus of claim 1 which further includes at least one sampled time unit object and wherein said processor is further configured with software for modifying said at least one sampled time unit object.

5. The distributed computer apparatus of claim 1 which further includes a user interface adapted to receive user feedback to enable a user to modify the attributes of said at least one event record object, said at least one feedback record object and said at least one participant record object.

6. The distributed computer apparatus of claim 5 wherein said user interface is further configured to display user feedback to at least one participant , said feedback comprised or user feedback instantiated by other users.

7. The distributed computer apparatus of claim 6 wherein said user interface is further configured to display user feedback to at least one participant in real time.

8. The distributed computer apparatus of claim 1 which further includes at least one data recipient interface for processing a request by a data recipient.

9. The distributed computer apparatus of claim 6 which is further configured with software for allowing said data recipient to invoke at least one function for processing and displaying data.

10. The distributed computer apparatus of claim 1 wherein said apparatus measures changes in at least one attribute of a plurality of feedback record objects.

11. The distributed computer apparatus of claim 1 wherein said processor is configured to measure changes in at least one attribute of a plurality of feedback record objects using a user feedback measurement function and display the results of said user feedback measurement function on a user interface.

12. The distributed computer apparatus of claim 1 in which said processor is further configured to measure changes in said at least one event record object and display updated event information on a user interface in real time.

13. The distributed computer apparatus of claim 1 in which said at least one feedback record object includes a group attribute.

14. The distributed computer apparatus of claim 13 wherein said at least one group attribute is associated with permissions to allow a user to modify said at least one feedback record object.

15. The distributed computer apparatus of claim 13 wherein said at least one group attribute is associated with permissions to allow a user to access said at least one event record object.

16. The distributed computer apparatus of claim 1 wherein said at least one participant record object is modified based on participant input from input hardware selected from a group consisting of a galvanometer, a keyboard, touch pad, a global positioning system, an electromyograph, a thermometer, an electrodermograph, an electroencephalograph, a photoplethysmograph, an electrocardiograph, a pneumograph, a capnometer, a video recorder and an audio recorder, a touch pad and a biofeedback device.

17. The distributed computer apparatus of claim 1 wherein said at least one participant record object further includes at least one unique device identification number attribute.

18. The distributed computer apparatus of claim 1 wherein said processor is further configured to measure changes in said at least one participant record object and display updated event information on a user interface.

19. The distributed computer apparatus of claim 1 which further includes a user interface, wherein said user interface further includes social networking website interface

20. The distributed computer apparatus of claim 1 which further includes a user feedback processor which is configured to process data obtained from at least one feedback record and update at least one data recipient object.

21. The distributed computer apparatus of claim 1 which further includes at least one backend revenue processing component for processing revenue from a data recipient.

22. The distributed computer apparatus of claim 1 which further includes at least one user interface capable of generating a report displaying processed data from at least one data recipient.

23. The distributed computer apparatus of claim 1 wherein a participant may instantiate an event object.

24. The distributed computer apparatus of claim 1 wherein event objects are stored in a data base which may be modified by users.
